(19) United States
(12) Patent Application Publication
(10) Pub. No.: US 2015/0036050 A1
(43) Pub. Date: Feb. 5, 2015

(54) TELEVISION CONTROL APPARATUS AND ASSOCIATED METHOD

(71) Applicant: MStar Semiconductor, Inc., Hsinchu Hsien (TW)

(72) Inventor: Hung-Chi Huang, Hsinchu County (TW)

(21) Appl. No.: 14/449,534

(22) Filed: Aug. 1, 2014

(30) Foreign Application Priority Data
Aug. 1, 2013 (TW) 102127653

(51) Int. Cl. H04N 5/45

(52) U.S. Cl. CPC H04N 5/45
USPC 348/568; 348/565

(57) ABSTRACT

A television control apparatus applied to a television system is provided. The television control apparatus includes a signal processing module and a combination module. The signal processing module obtains a first frame and a second frame from a first video signal and a second video signal, respectively. While the second frame is displayed in a display area of the television system, the combination module extracts a part of the first frame as a sub-image, and causes the sub-image to be displayed in a sub-region of the display area. The sub-region is smaller than the first frame.

This application claims the benefit of Taiwan application Serial No. 102127653, filed Aug. 1, 2013, the subject matter of which is incorporated herein by reference.

### BACKGROUND OF THE INVENTION

1. Field of the Invention

The invention relates in general to a television control method and an associated method, and more particularly to a television control apparatus capable of displaying a partial image of another signal source in a sub-region of a main display region and an associated method.

2. Description of the Related Art

Television systems that can display still and/or motion pictures are one the most important electronics products in the modern information society. Video conference systems, security monitoring systems, all-in-one computers, projector display systems, video recorders, and multimedia players of optical disks/hard disks/non-volatile memory devices, as well as various wearable, handheld and portable products such as mobile phones, navigation systems, and digital cameras/video cameras, can all be regarded as television systems.

A television system includes a screen, whose display region displays a picture and plays video signals. Due to diversified video contents, it is a common wish of users to effectively integrate video signals of different sources into one display region. The current display control technologies do offer a picture-in-picture (PIP) function. When two video signals are simultaneously played by the PIP technology, a frame of the second video signal fills the display region to form a background (main-picture), while a frame of the first video signal is entirely displayed in a sub-region (sub-picture) in the display region.

However, the known PIP technology yet has room for improvement. For example, in a conventional solution, the sub-region can only fixedly display a complete frame of the first video signal instead of extracting and emphasizing an important part in the frame, and is incapable of eliminating a part that is insignificant to a user. That is to say, the conventional solution is incapable of effectively displaying image information that a user most concerns in the sub-region having a smaller area. Further, in the conventional solution, the sub-region/sub-picture is a constant rectangle, thus lacking application flexibilities and adaptation abilities for meeting individual requirements of different users.

### SUMMARY OF THE INVENTION

The invention is directed to a television control apparatus applied to a television system. The television system has a display area. The television control apparatus includes a signal processing module and a combination module. The signal processing module obtains a first frame and a second frame from a first video signal and a second video signal, respectively, and extracts a part of the first frame as a sub-image. While the second frame is displayed in the display area, the combination module causes the sub-image to be displayed in a sub-region of the display area. The sub-image is smaller than the first frame. For example, pixels covered by the sub-image may be a sub-set of all pixels in the first frame.

In one embodiment, the signal processing module further obtains a second frame from the second video signal. For example, the signal processing module includes a plurality of decoding modules. Each of the decoding modules decodes the first video signal and the second video signal to obtain the first frame and the second frame, respectively. The combination module superimposes the sub-image of the first frame onto the second frame, such that the second frame is displayed in the display region as a background and the sub-image is displayed in the sub-region as a foreground.

In one embodiment, the television control apparatus of the present invention may include an access module that accesses a database. The database stores a plurality of display layouts. Each of the display layouts records various kinds of extraction information and sub-region information, and may further include a set of conversion information. The television control apparatus may select one of the display layouts. According to the extraction information (e.g., a position of the sub-image) recorded in the selected display layout, the signal processing module extracts the sub-image. According to the sub-region information (e.g., a position of the sub-region) recorded in the selected display layout, the combination module causes the sub-image to be displayed in the sub-region. The conversion information records details for converting the sub-image to the corresponding sub-region.

In one embodiment, the television control apparatus may select the display layout according to a user control received, and/or may automatically select the display layout. For example, the access module may automatically access the database and select the display layout according to channels corresponding to the first video signal and the second video signal, and/or may automatically access the data base and select an appropriate display layout according to an operation context of the television system.

In one embodiment, the television control apparatus is operable in a configuration mode and a playback mode, and further includes a configuration module. When the television control apparatus operates in the configuration mode, the configuration module determines the part (i.e., the sub-image) of the first frame according to an instruction, and/or determines the sub-region of the display area according to an instruction. For example, the configuration module may allow a plurality of positioning points to be displayed in the display area, and the instruction corresponds to one of these positioning points. For example, the television control apparatus may determine the position of the sub-region selected according to an instruction of a user. When the television control apparatus operates in the playback mode, the combination module allows the sub-image to be displayed in the sub-region according to the position of the sub-region determined by the configuration module. A shape of the sub-image and/or a shape of the sub-region is/are not limited to a rectangle.

The present invention further discloses a method for controlling a television system. Details of the method can be referred from the description associated with the above television control apparatus, and shall be omitted herein.

The above and other aspects of the invention will become better understood with regard to the following detailed description of the preferred but non-limiting embodiments. The following description is made with reference to the accompanying drawings.

### BRIEF DESCRIPTION OF THE DRAWINGS

FIG. 1 is a schematic diagram of a television system according to an embodiment of the present invention;

FIG. 2 is a schematic diagram of an exemplary operation of the television system in FIG. 1 according to an embodiment of the present invention;

FIG. 3 is a schematic diagram of a television system according to another embodiment of the present invention;

FIG. 4 and FIG. 5 are schematic diagrams of exemplary operations of the television system in FIG. 3 according to other embodiments of the present invention;

FIG. 6 is a schematic diagram of a display layout in FIG. 3 according to an embodiment of the present invention;

FIG. 7 and FIG. 8 are schematic diagrams of exemplary operations of the television system in FIG. 3;

FIG. 9 is a schematic diagram of circuits included in the signal processing module in FIG. 1 and FIG. 3; and

FIG. 10 is a flowchart of a method according to an embodiment of the present invention.

### DETAILED DESCRIPTION OF THE INVENTION

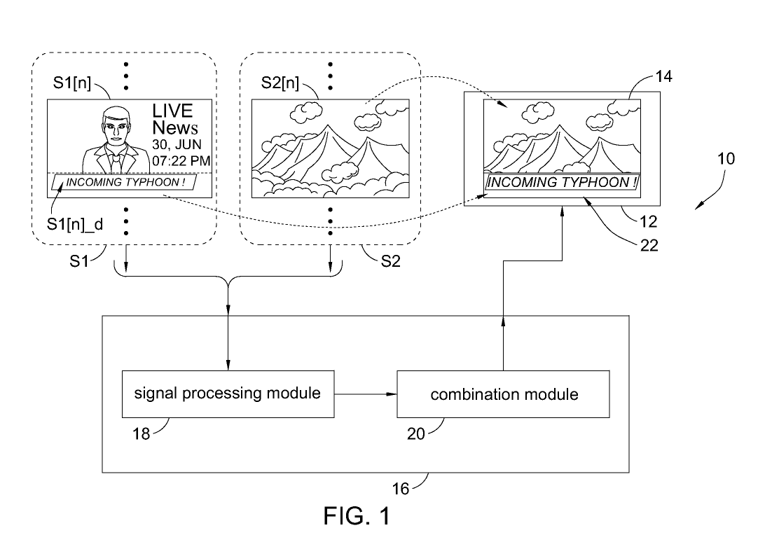

FIG. 1 is a schematic diagram of a television system 10 according to an embodiment of the present invention. The television system 10 may include a screen 12 (e.g., a liquid-crystal display (LCD)) and a television control apparatus 16. For example, the television control apparatus 16 may be a television control chip, or may include peripheral circuits and supporting devices of the television control chip, e.g., driver chips, image processing chips and/or volatile/non-volatile storage devices. The television control apparatus 16, coupled to the screen 12, controls the screen 12 to display a still and/or motion picture in a display region 14 of the screen 12.

The television control apparatus 16 may include a signal processing module 18, and a combination module 20 coupled to the signal processing module 18. The signal processing module 18 may receive multiple video signals, e.g., two exemplary video signals S1 and S2 in FIG. 1. The video signal S1 may include one or multiple frames, e.g., a frame S1[n]. Similarly, the video signal S2 may also include one or multiple frames, e.g., a frame S2[n]. The signal processing module 18 may obtain the frames S1[n] and S2[n] from the video signals S1 and S2, respectively.

According to the frames S2[n] and S1[n] provided by the signal processing module 18, the combination module 20 may fill and display the frame S2[n] in the display region 14, extract a part (e.g., the lower part of the frame in FIG. 1) of the frame S1[n] as a sub-image S1[n]_d, and display the sub-image S1[n]_d in a sub-region 22 of the display region 14. That is, the combination module 20 causes the sub-image S1[n]_d to be displayed in the sub-region 22 in the display region 14, while the remaining area of the display region 14 displays the frame S2[n]. The sub-image S1[n]_d is smaller than the frame S1[n].

In other words, in addition to displaying the frame S2[n], the television control apparatus 16 is also capable of extracting the sub-image S1[n]_d to be emphasized from the frame S1[n] and fully displaying the sub-image S1[n]_d by utilizing the sub-region 22. As such, an insignificant secondary part in the frame S1[n] can be eliminated instead of having the secondary part pointlessly occupy the limited area of the sub-region 22. For example, the video signal S2 may be primary contents desired by the user, and the video signal S1 may be contents provided by a news channel. By applying the present invention, a part of news headlines in the video signal S1 may be extracted as the sub-image and displayed in the sub-region 22. Thus, while watching the video signal S2, the news headlines may be at the same time well-noted.

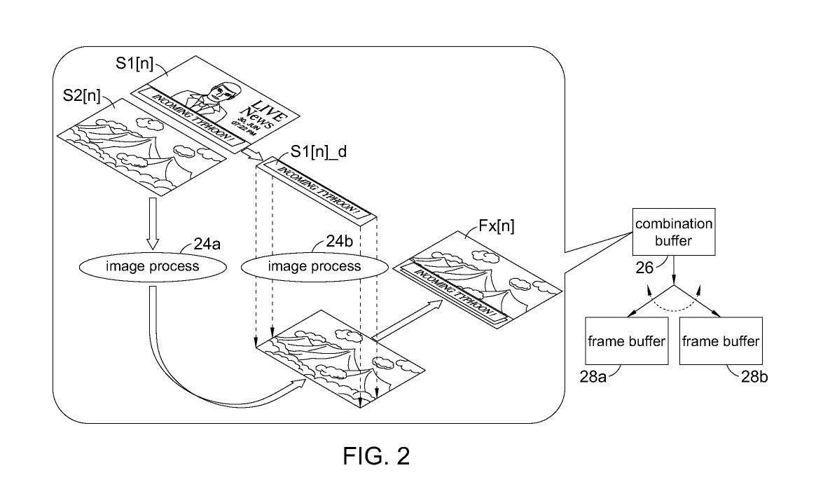

In continuation of the embodiment in FIG. 1, FIG. 2 shows an operation example of the television control apparatus 16 according to an embodiment. In the embodiment, the combination module 20 may superimpose the sub-image S1[n]_d of the frame S1[n] onto the frame S2[n] according to a size and a position of the sub-region 22, so as to display the frame S2[n] in the display region 14 as a background and at the same time display the sub-image S1[n]_d in the sub-region 22 as a foreground. After obtaining the frames S1[n] and S2[n] from the video signals S1 and S2 (FIG. 1), an image process 24a may be performed on the frame S2[n], e.g., scaling the frame S2[n] according to a resolution of the display region 14 (FIG. 1). Further, an image process 24b is performed on the sub-image S1[n]_d extracted from the frame S1[n], e.g., scaling and adjusting the sub-image S1[n]_d according to the size of the sub-region 12. The processed sub-image S1[n]_d may then be superimposed onto the processed frame S2[n] to form a combined frame Fx[n] that is to be displayed in the display region 14.

In one embodiment, the combination module 20 may access (and/or include) a combination buffer 26 and two (or more) frame buffers, e.g., frame buffers 28a and 28b. The combination process of the sub-image S1[n]_d and the frame S2[n] may be performed by utilizing a memory space provided by the combination buffer 26, and the combined frame Fx[n] may be temporarily stored in the combination buffer 26. To play the combined frame Fx[n], the combined frame Fx[n] may be fetched from the combination buffer 26 to the frame buffer 28a, which further outputs the combined frame Fx[n] to the screen 12 (FIG. 1). While the frame buffer 28a outputs the combined frame Fx[n], the combination buffer 26 may be utilized to simultaneously form a next combined frame Fx[n+1] (not shown), and the combined frame Fx[n+1] is fetched to the other frame buffer 28b. To play the combined frame FX[n+1], the frame buffer 28b outputs the combined buffer Fx[n+1], while the other frame buffer 28a prepares to fetch a next combined frame Fx[n+2] from the combination buffer 26. In other words, the two frame buffers 28a and 28b operate alternately—when either of the two buffers outputs a combined frame to the screen, the other is utilized to temporarily store a next combined frame.

In the frame combination process of another embodiment, the combination module 20 fetches the frames S1[n] and S2[n] according to the position of the sub-region 12, and directly outputs the frames S1[n] and S2[n] without superimposing the frames to each other. For example, when the combination module 20 outputs an i^{th} scan line (not shown) of the combined frame Fx[n], if the scan line does not intersect with the sub-region 12, the combination module 20 may fetch the i^{th} scan line in the frame S2[n] and output the fetched i^{th} scan line as the i^{th} scan line of the combined frame Fx[n]. If the i^{th} scan line intersects with the sub-region 12 at a j1^{st} pixel to a j2^{nd} pixel (not shown), when outputting the i^{th} scan line of the combined frame Fx[n], the combination module 20 may fetch the 1^{st} to the j1^{st} of the i^{th} scan line from the frame S2[n], and further fetch the j2^{th} pixel to the last pixel of the i^{th} scan line from the frame S1[n].

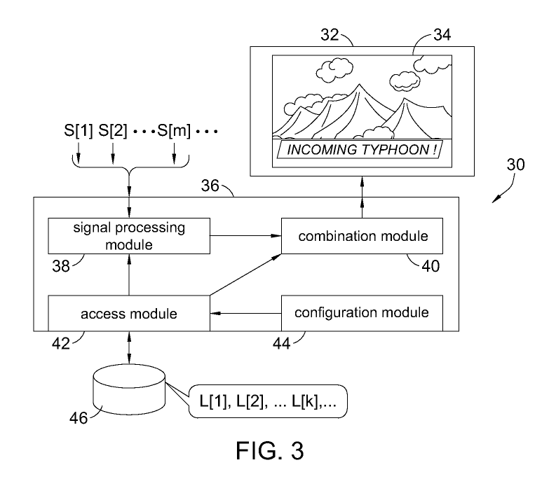

FIG. 3 shows a schematic diagram of a television system 30 according to an embodiment of the present invention. The television system 30 may include a screen 32 and a television control apparatus 36. The television control apparatus 36, coupled to the screen 32, controls the screen 32 to display still and/or motion pictures in a display region 34 of the screen 32. The television control apparatus 36 may include a signal processing module 38, a combination module 40, an access module 42, and a configuration module 44. The signal processing module 38 may obtain frames from a plurality of video signals (e.g., video signals S[1], S[2] to S[m]). The combination module 40 is coupled to the signal processing module 38 and the access module 42.

The access module 42 is coupled to a database 46 to access the database 46. The database 46 may be implemented by a non-volatile memory, and may be a part of the television control apparatus 36 (e.g., an embedded memory) or an external memory device externally connected to the television control apparatus 36. The database 46 stores one or multiple display layouts L[1], L[2] to L[k]. Each of the display layouts L[.] records coordinates, position and/or size of one or multiple sub-regions. The television control apparatus 36 selects a display layout L[k_selected] (not shown) from these display layouts L[.]. After the signal processing module 38 obtains frames of one or multiple video signals, the combination module 40 extracts one or multiple sub-images from the frames of the one or multiple video signals according to the selected display layout L[k_selected], and causes the sub-image(s) to be displayed in the corresponding sub-region(s) according to the selected display layout L[k_selected].

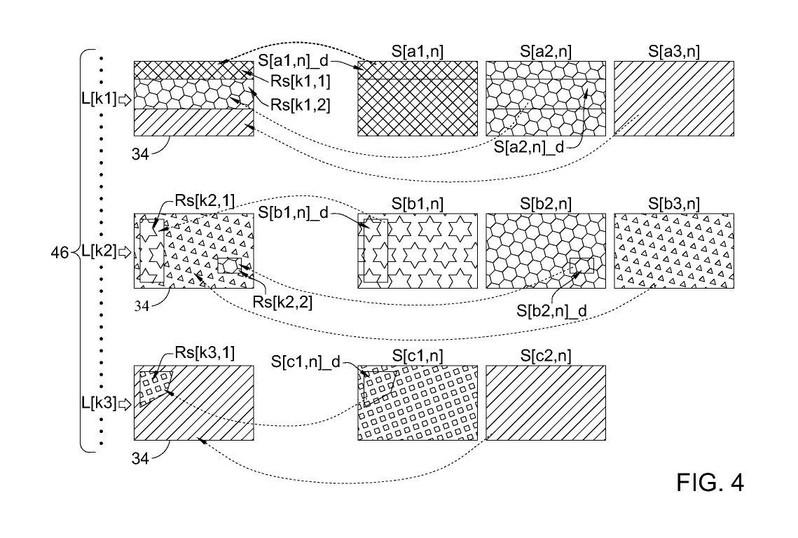

In continuation of the embodiment in FIG. 3, FIG. 4 shows a schematic diagram of several exemplary display layouts in the database 46, e.g., display layouts L[k1], L[k2] ad L[k3]. The display layout L[k1] allots two sub-regions Rs[k1, 1] and Rs[k1, 2] in the display region 34 to display two sub-images. According to the display layout L[k1], the signal processing module 38 (FIG. 3) obtains frames S[a1, n], S[a2, n] and S[a3, n] of video signals S[a1], S[a2] and S[a3] (not shown). The combination module 40 respectively extracts sub-images S[a1, n]_d and S[a2, n]_d from the frames S[a1, n] and S[a2, n], and respectively combines the sub-images S[a1, n]_d and S[a2, n]_d to the sub-regions Rs[k1, 1] and Rs[k1, 2] to serve as foregrounds, which are then superimposed onto a background frame, e.g., the frame S[a3, n].

The display layout L[k2] provides the display region 34 with two sub-regions Rs[k2, 1] and Rs[k2, 2] for displaying two sub-images. When the display layout L[k2] is selected, the signal processing module 38 may obtain frames S[b1, n], S[b2, n] and S[b3, n] of video signals S[b1] (not shown), S[b2] (not shown) and Sb[3] (not shown). The combination module 40 respectively extracts sub-images S[b1, n]_d and S[b2, n]_d from the frames S[b1, n] and S[b2, n], and respectively combines the sub-images S[b1, n]_d and S[b2, n]_d to the sub-regions Rs[k2, 1] and Rs[k2, 2] to serve as foregrounds, which are then superimposed onto a background frame, e.g., the frame S[b3, n].

The display layouts L[k1] and L[k2] both provide two sub-regions. However, these display layouts may be configured with different numbers and/or different types (different shapes, different positions, and/or different sizes) of sub-regions. For example, the sub-regions Rs[k1, 1] and Rs[k1, 2] of the display layout L[k1] may be two trans-rectangles that extend horizontally, while the sub-regions Rs[k2, 1] and Rs[k2, 2] of the display layout L[k2] may be rectangles at the left side and at the lower right side.

Apart from being rectangular, the sub-regions may also be polygonal. Referring to FIG. 4, the display layout L[k3] includes an irregular polygonal sub-region Rs[k3, 1]. When the display layout L[k3] is selected, the television control apparatus 30 may extract an irregularly shaped sub-image S[c1, n]_d from a frame S[c1, n] of a video signal S[c1] to correspond to the sub-region Rs[k3, 1]. The sub-image S[c1, n]_d may then be displayed in the sub-region Rs[k3, 1] and be superimposed onto a background frame (e.g., a frame S[c2, n] of a signal source S[c2]).

Through different display layouts of the present invention, the presentation of sub-images is offered with multiple options that significantly enhance the flexibilities and fun for viewing video contents for a user. In one embodiment, the television control apparatus 36 receives a user control and accesses the user-desired display layout from the database 46 according to the selection of the user, and combines the images and displays the picture on the screen 32 according the display layout selected by the user. For example, the television control apparatus 36 is operable in a user selection mode and a playback mode. When the user selects the display layout, the television control apparatus 36 may enter the user selection mode, and present various display layouts in the database 46 by applying an on-screen display (OSD) for the user to preview sub-region configurations of the different display layouts. Upon receiving the user selection control, the television control apparatus 36 may access the user-selected display layout from the database 46 and end the user selection mode to enter the playback mode. In the playback mode, the television control apparatus 36 may extract sub-images from different video signals according to the user-selected display layout, combine the extracted sub-images to generate combined frames, and display the combined frames. The user selection control on the television control apparatus 36 may be achieved through a remote controller, voice control, touch control, and/or somatosensory control.

In one embodiment, in addition to selecting the desired display layout by a user, the television control apparatus 36 may also automatically select a specific display layout. For example, the display layout in the database is automatically accessed according to an operation context of the television control apparatus 36. For example, the television control apparatus 36 may automatically select the display layout according to a channel that a user wishes to watch, e.g., when the user wishes to select a sports channel as the video signal source of the sub-region, the television control apparatus 36 then automatically selects a display layout that designs a position of the score board as of the sub-image. Further, the television control apparatus 36 may automatically select the display layout according to the time, e.g., the television control apparatus 36 automatically selects a predetermined display layout at a certain time and automatically switches to another display layout at another time. Further, the television control apparatus 36 automatically selects a predetermined display layout when triggered by a signal (or a device). For example, the television control apparatus 36 may continually monitor surrounding sounds, and automatically selects a corresponding display layout when a predetermined condition is satisfied. For example, the predetermined condition is having recognized a predetermined type (or a predetermined frequency) of sound from the sounds, and/or when the volume is higher (or lower) than a predetermined threshold. Further, the television control apparatus 36 may automatically select a predetermined display layout according to a sensing result of an optical sensor, e.g., selecting a predetermined display layout when the brightness is lower (or higher) than a predetermined threshold. Further, the television control apparatus 36, coordinating with a video camera in front of the screen, may automatically select a predetermined display layout according to an image recognition result. For example, when a number of users in front of the screen (a number of recognizable user faces) is greater (or smaller) than a predetermined number, the television control apparatus 36 may automatically select a predetermined display layout. Further, when the face of a predetermined user is recognized (or not recognized), the television control apparatus 36 may automatically select a predetermined display layout. Further, when a motion (e.g., a gesture or pupil-tracking) captured in front of the screen matches a predetermined type, the television control apparatus 36 automatically selects a predetermined display layout.

In the display layouts L[.], the sub-images displayed in the different sub-regions Rs[., .] may be from frames of different video signals or from the same frame of the same video signal. For example, in the exemplary display layout L[k2] in FIG. 4, the sub-images of the sub-regions Rs[k2, 1] and Rs[k2, 2] may be extracted from the same frame, i.e., the subscripts b1 and b2 may be equal, and the frames S[b1, n] and S[b2, n] may be the same frame of the same signal source. Further, in the same display layout L[.], the sub-images displayed in different sub-regions may be different frames extracted from the same video signal. Taking the display layout L[k2] for example, the sub-images to be displayed in the sub-regions Rs[k2, 1] and Rs[k2, 2] may be extracted from the frames S[b1, n] and S[b1, n-m].

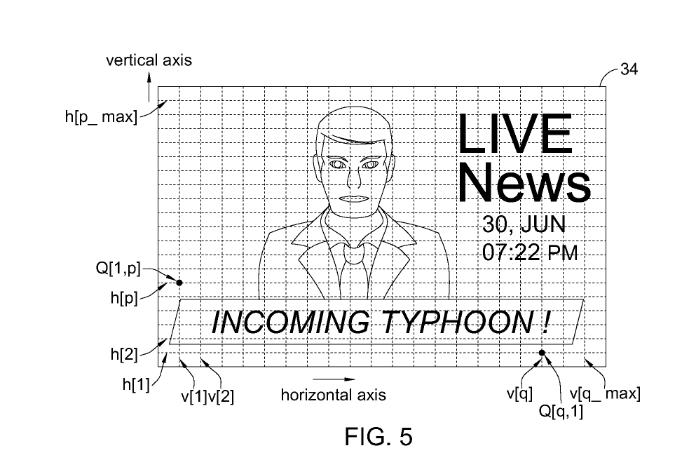

In the embodiment in FIG. 3, the display layouts L[.] in the database 46 may be pre-built-in, or may be established or edited by a user. The configuration module 44 of the television control apparatus 36 assists the user to define the display layouts, e.g., defining the sub-region in the display layouts. In addition to the abovementioned user selection mode and playback mode, the television control apparatus 36 is further operable in a configuration mode. FIG. 5 shows an exemplary operation of the configuration mode according to an embodiment. In the configuration mode, the configuration module 44 (FIG. 3) may utilize the OSD to display a plurality of positioning marks in the display region 34, e.g., displaying horizontal grid lines h[1], h[2] to h[p_max] and vertical grid lines v[1], v[2] to v[q_max]. From intersections (i.e., positioning points) of the horizontal grid lines and vertical grid lines, the user may select and define vertices of the sub-region. The television control apparatus 36 receives the user control and displays the user-selected intersections in the display region 34 for the user to preview positions of the selected intersections. In FIG. 5, two vertices Q[q, 1] (the intersection of the grid lines v[q] and h[1]) and Q[1, p] (the intersection of the grid lines v[1] and h[p]) are depicted as an example.

With multiple vertices collected, the configuration module 44 may determine the position and range of the sub-region, and the position of the sub-region may be recorded in the corresponding display layout. For example, assuming the user configures three vertices, a triangular sub-region may be defined to display a triangular sub-image of a frame. Further, the user may also select the shape of the sub-region, and the configuration module 44 provides geometric parameters and necessary configuration steps for the selected shape. For example, when the sub-region is a rectangle, the user may select only two vertices as two ends of a diagonal line of the rectangle. Alternatively, the user may select only one point as a center of the rectangle (or a vertex), and sets the length and width of the rectangle by addition/subtraction. Further, instead of having the configuration module 44 showing grids and positioning signals, the positions of the vertices may be entirely determined by the user. Further, the configuration module 44 may realize the other sub-region design/editing methods. For example, a sub-region of another display layout is imported to the currently configured display layout. For example, multiple built-in sub-regions are provided for the user to import these built-in sub-regions to the currently configured display layout. For example, the user is allowed to add, delete and move the vertices of the sub-regions, move the positions of the sub-regions without changing the shapes of the sub-regions, scale the sub-regions, and/or rotate the sub-regions. When the television control apparatus 36 operates in the playback mode, the access module 42 may access the display layouts previously configured by the configuration module 44 from the database 46. Accordingly, the signal processing module 38 may extract sub-images, which are then combined by the combination module 40 and displayed in the sub-regions.

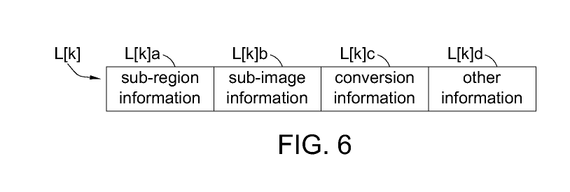

FIG. 6 shows a schematic diagram of information included in a display layout L[k] according to an embodiment of the present invention. The display layout L[k] includes sub-region information L[k]a that records the position(s) and/or size(s) of one or multiple sub-regions for defining one or multiple sub-regions in the display region 34 (FIG. 4). In an embodiment of the present invention, the television control apparatus 36 direct proportionally extracts a sub-image from a complete frame according to a geometric relationship between a sub-region and a complete display region. For example, in the display layout L[k1] in FIG. 4, assuming that the vertical position of the sub-region Rs[k1, 1] is at a position one-third from the top of the display region 34, when extracting the sub-image S[a1, n]_d from the frame S[a1, n], the first one-third of the frame S[a1, n] is extracted as the sub-image S[a1, n]_d.

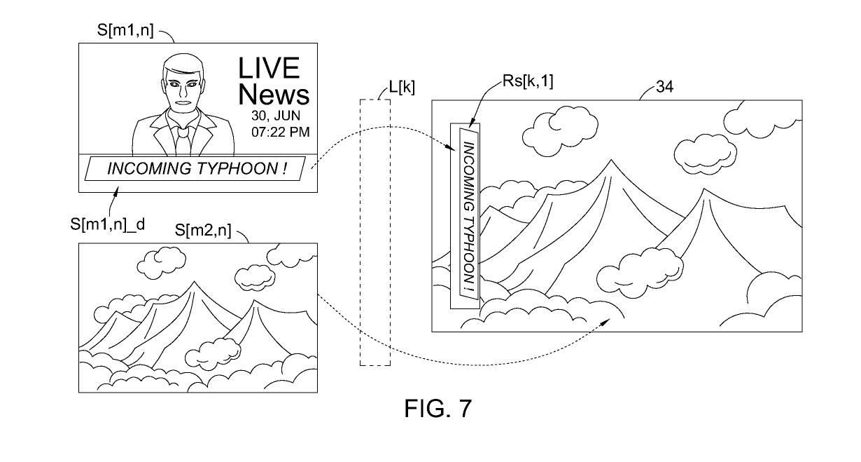

In an embodiment of the present invention, the geometric relationship between the sub-images and frames may be independent from the geometric relationship between the sub-regions and display region. Further, the two geometric relationships need not be directly proportional. Therefore, the display layout L[k] may selectively include sub-image information L[k]b and conversion information L[k]c. The sub-image information L[k]b records the position(s) and/or size(s) of one or multiple sub-images in the frame, and the conversion information L[k]c is for converting the sub-image(s) such that the converted sub-image(s) match/matches the sub-region. For example, referring to the embodiment in FIG. 7, in this example, the display layout L[k] has the sub-image S[m1, n]_d of the frame S[m1, n] be rotated (and scaled), and displayed in the sub-region Rs[k, 1] of the display region 34 to be superimposed on top of the background of the frame S[m2, n]. To realize such picture combination, the sub-region information L[k]a of the display layout L[k] records the position (and/or the size) of the sub-region Rs[k, 1] in the display region 34, the sub-image information L[k]b records the position (and/or the size) of the sub-image S[m1, n]_d in the frame S[m1, n], and the conversion information L[k]c records the image conversion and/or image process (e.g., rotation or scaling) required for filling the sub-image S[m1, n]_d to the sub-region Rs[k, 1].

The display layout L[k] may selective include other information L[k]d. For example, the information L[k]d may record the signal sources of the sub-images, e.g., from which program(s) of which channel(s) the sub-images are to be extracted. Further, the information L[k] may include details for combining the sub-images with the background frame, e.g., AND operation, OR operation, addition or subtraction of pixel data to combine the sub-images to the background frame.

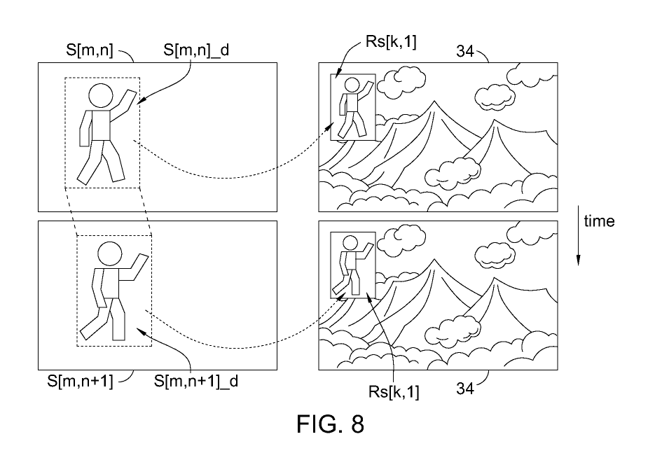

The positions and sizes of the sub-regions and/or sub-images may be automatically configured by the television control apparatus 36. For example, the television control apparatus 36 may perform image analysis for a particular frame, and automatically gather pixels that satisfy a predetermined condition as a sub-image that is then filled into the sub-region. Referring to the example shown in FIG. 8, the television control apparatus 36 may perform a motion detection on a series of frames S[m, n] and S[m, n+1] of the same signal source, automatically determine the positions of the sub-images S[m, n]_d and S[m, n+1]_d according to the motion parts, and accordingly extract the sub-images S[m, n]_d and S[m, n+1]_d, so as to show the sub-images S[m, n]_d and S[m, n+1]_d in the sub-region Rs[k, 1] in the display region 34. In the display region 34, the position of the sub-region Rs[k, 1] may be fixed, or may be mobile according to the positions of the sub-images.

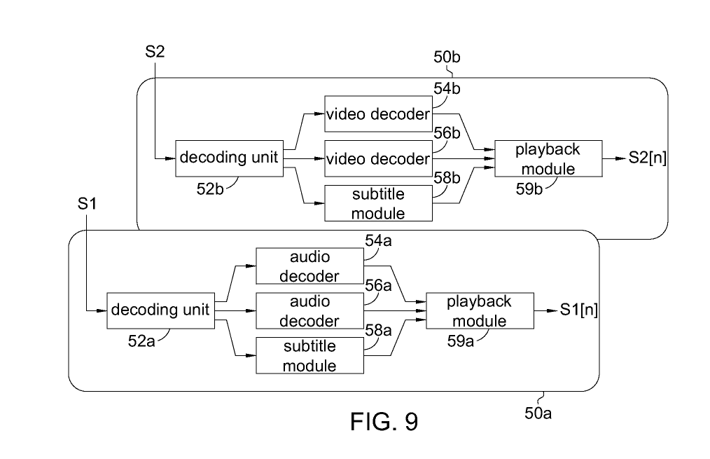

In the television systems 10 and 30 in FIG. 1 and FIG. 3, the signal processing modules 18 and 38 may each include one or multiple decoding modules, e.g., two decoding modules 50a and 50b in FIG. 9. Each decoding module obtains frames from a corresponding video signal. For example, the decoding modules 50a and 50b may obtain the frames S1[n] and S2[n] from the video signals S1 and S2, respectively. The structures and functions of the decoding modules 50a and 50b may be identical. Taking the decoding module 50a for example, the decoding module 50a may include a decoding unit 52a, an audio decoder 54a, a video decoder 56a, a subtitle module 58a, and a playback module 59a. In the decoding module 50a, the decoding unit 52a, coupled to the video signal S1, sends audio contents, image contents and subtitle contents decoded from the video signal S1 to the audio decoder 54a, the video decoder 56a and the subtitle module 58a, respectively. As such, the audio decoder 54a, the video decoder 56a and the subtitle module 58a obtain and send audio, frames and subtitles to the playback module 59a. The playback module 59a then outputs the audio and the frame S1[n] (or the frame S1[n] added with subtitles). The decoding module 50b may include a decoding unit 52b, an audio decoder 54b, a video decoder 56b, a subtitle module 58b and a playback module 59b. The structures and functions of the units in the decoding module 50b are similar to the decoding unit 52a, the audio decoder 54a, the video decoder 56a, the subtitle module 58a and the playback module 59a, and shall be omitted herein. When the television control apparatus 16 or 36 of the television system 10 or 30 performs an application program to realize the present invention, the decoding modules 50a and 50b may be controlled through service routines of an operating system.

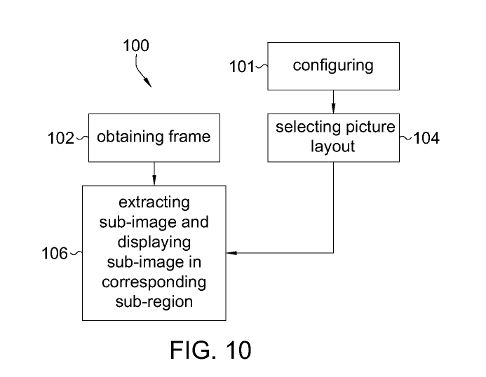

FIG. 10 shows a flowchart of a process 100 according to an embodiment of the present invention for controlling a television system. For example, the television control apparatus 36 in FIG. 3 of the present invention may control the television system 30 according to the process 100. The process 100 includes the following steps.

In step 102, a frame is obtained. For example, a first video signal and a second video signal are decoded, respectively, to obtain a first frame and a second frame, respectively.

In step 104, a database (e.g., the database 46 in FIG. 3) is accessed, and a display layout is selected from a plurality of display layouts stored in the database. In the database, the display layouts record various kinds of extraction information (e.g., positions for extracting sub-images) and information of sub-region (e.g., a position of a sub-region), and may include conversion information. For example, the conversion information may record details for converting the sub-images in a display layout to corresponding sub-regions. When performing step 104, the display layout to be applied may be user-selected. Alternatively, the database may be automatically accessed according to an operation context of the television system to select a corresponding display layout. For example, the database may be accessed according to channels corresponding to the first video signal and the second video signal.

In step 106, after selecting the display layout in step 104, a part of the first frame is extracted as the sub-image according to the extraction information recorded in the selected display layout, and the sub-image is displayed in the corresponding sub-region according to the sub-region information recorded in the selected display layout.

The process 100 may selectively include step 101. In step 101, the television system is rendered to operate in a configuration mode, and the sub-images and/or sub-regions of a display layout are determined according to an instruction, e.g., an instruction for determining the position of the extracted sub-image and the position of the sub-region. In an embodiment, when performing step 101, a plurality of positioning points are displayed in a display area, and the instruction corresponds to one of the positioning points. The configuration mode may be ended after having performed step 101. The process 100 may then proceed to the playback mode in step 102 and step 106.

In conclusion, compared to the conventional PIP technology, the present invention is capable of displaying sub-images having different video contents in the sub-region to more effectively display different contents in a multi-tasking manner. Further, the present invention offers highly diversified application flexibilities that can be personalized and customized to satisfy individual requirements of different users.

While the invention has been described by way of example and in terms of the preferred embodiment, it is to be understood that the invention is not limited thereto. On the contrary, it is intended to cover various modifications and similar arrangements and procedures, and the scope of the appended claims therefore should be accorded the broadest interpretation so as to encompass all such modifications and similar arrangements and procedures.

What is claimed is:

1. A television control apparatus, applied to a television system, the television system being configured to have a display area, the television control apparatus comprising:
a signal processing module, configured to obtain a first frame and a second frame from a first video signal and a second video signal, respectively; and
a combination module, configured to extract a part of the first frame as a sub-image that is to be displayed in a sub-region of the display area while the second frame is displayed in the display area;
wherein, a scope of the sub-image is smaller than a scope of the first frame.

2. The television control apparatus according to claim 1, wherein the signal processing module comprises:
a first decoding module and a second decoding module, configured to decode the first video signal and the second video signal, respectively, to obtain the first frame and the second frame.

3. The television control apparatus according to claim 1, further comprising:
an access module, configured to access a plurality of display layouts, which record corresponding extraction information and sub-region information, respectively;
wherein, the television control apparatus selects one of the display layouts, the combination module extracts the sub-image from the first frame according to the extraction information recorded in the selected display layout, and causes the sub-image to be displayed in the sub-region according to the sub-region information recorded in the selected display layout.

4. The television control apparatus according to claim 3, selecting one of the display layouts according to channels corresponding to the first video signal and the second video signal.

5. The television control apparatus according to claim 3, selecting one of the display layouts according to an operation context of the television system, wherein the operation context comprises a time, a sensing result, or a recognition result.

6. The television control apparatus according to claim 3, wherein each of the display layouts further comprises conversion information for converting the sub-image to match the sub-region.

7. The television control apparatus according to claim 1, operable in a configuration mode, further comprising:
a configuration module, configured to determine the part of the first frame according to an instruction when the television control apparatus operates in the configuration mode.

8. The television control apparatus according to claim 7, wherein the configuration module allows a plurality of positioning points to be displayed in the display area, and the instruction corresponds to one of the positioning points.

9. The television control apparatus according to claim 1, operable in a configuration mode, further comprising:
a configuration module, configured to determine the sub-region according to an instruction when the television control apparatus operates in the configuration mode.

10. A method for controlling a television system, the television system comprises a display area, the method comprising:
obtaining a first frame and a second frame from a first video signal and a second video signal, respectively; and
extracting a part of the first frame as a sub-image that is to be displayed in a sub-region of the display area while the second frame is displayed in the display area; wherein, a scope of the sub-image is smaller than a scope of the first frame.

11. The method according to claim 10, further comprising:
decoding the first video signal and the second video signal to obtain the first frame and the second frame, respectively.

12. The method according to claim 10, further comprising:
selecting one of a plurality of display layouts, which record corresponding extraction information and sub-region information, respectively; and
accessing the selected display layouts, extracting the sub-image from the first frame according to the extraction information recorded in the selected display layout, and causing the sub-image to be displayed in the sub-region according to the sub-region information recorded in the selected display layout.

13. The method according to claim 12, wherein the step of selecting one of a plurality of display layouts comprises selecting one of the display layouts according to channels corresponding to the first video signal and the second video signal.

14. The method according to claim 12, wherein the step of selecting one of a plurality of display layouts comprises selecting one of the display layouts according to an operation context of the television system, wherein the operation context comprises a time, a sensing result, or a recognition result.

15. The method according to claim 12, wherein the display layouts further comprise conversion information for converting the sub-image to match the sub-region.

16. The method according to claim 10, further comprising:
rendering the television system to operate in a configuration mode, and determining the part in the first frame according to an instruction.

17. The method according to claim 16, further comprising:
in the configuration mode, allowing a plurality of positioning points to be displayed in the display area; wherein the instruction corresponds to one of the positioning points.

18. The method according to claim 10, further comprising:
rendering the television system to operate in a configuration mode to determine the sub-region according to an instruction.
